(19) United States
(12) Patent Application Publication
(10) Pub. No.: US 2011/0307801 A1
(43) Pub. Date: Dec. 15, 2011

(54) CONTRIBUTOR COMPENSATION SYSTEM AND METHOD

(75) Inventor: Mark A. Sherman, West Palm Beach, FL (US)

(73) Assignee: Wikiatlas Corp.

(21) Appl. No.: 12/809,565

(22) PCT Filed: Dec. 21, 2008
(86) PCT No.: PCT/US08/87884

§ 371 Date: Aug. 26, 2011

Related U.S. Application Data
(60) Provisional application No. 61/016,044, filed on Dec. 21, 2007.
(60) Provisional application No. 61/130,256, filed on May 29, 2008.

(51) Int. Cl. G06F 3/01

(52) U.S. Cl. 715/751

(57) ABSTRACT

Described are computer-based methods and apparatuses, including computer program products, for contributor compensation. In some embodiments, a user contributes content data to a wiki. The user is compensated for the contribution of the content data to the wiki. In other embodiments, a reviewer reviews contributed content data. The review is compensated for the review of the contributed content data.

### CROSS REFERENCE TO RELATED APPLICATIONS

This is the US National Phase of PCT/US2008/087884 filed on Dec. 21, 2008, and claims the benefit of priority to U.S. Provisional Application Ser. No. 61/061,044, filed Dec. 21, 2007 and U.S. Provisional Application Ser. No. 61/130,256, filed May 29, 2008, all of which are hereby incorporated by reference in their entirety.

### FIELD OF THE INVENTION

The present invention relates generally to computer-based methods and apparatuses, including computer program products, for contributor compensation.

### BACKGROUND

With the convergence of GPS devices, cell phones, the Apple iPhone, Google Earth, Navigon, mapping applications, and Google's new Android mobile technology platform, the need for location-based information has reached a frenzied pace. Although a number of companies have commenced the aggregation of data (e.g., Google, Zillow, WikiMapia, Wikipedia, TripAdvisor), their business models do not allow for the incentivisation of the public for providing the volumes of data necessary to reach critical mass. Improvements are needed in this technology field.

### SUMMARY OF THE INVENTION

One approach is a method for compensating a contribution. The method includes receiving, via a communication module, a content contribution request from a client device; determining, by a user compensation module, a compensation amount based on the content contribution request; and modifying, by the user compensation module, a contributor account based on the compensation amount.

Another approach is a method for gathering data. The method includes triggering, via a user collaboration module, a contributor for content contribution to a wiki based on a location of the content contributor.

Another approach is a system for compensating a contribution. The system includes a communication module to receive a content contribution request from a client device. The system further includes a first compensation module to determine a compensation amount based on the content contribution request and modify a contributor account based on the compensation amount.

Another approach is a system for gathering data. The system includes a user collaboration module to trigger a contributor for content contribution to a wiki based on a location of the content contributor. The system further includes a communication module for receiving the content contribution request from the contributor.

Another approach is a method for gathering data. The method includes receiving, via a communication module, information regarding at least location information of a user. The method further includes determining, by a user collaboration module, traffic condition information proximate to the user by determining a speed of the user from the location information and compensating, by a user compensation module, the user for providing the location information.

Another approach is a method for operating a wiki. The method includes receiving, via a communication module, a request for a location-specific data capture and requesting, via a database interface module, the location-specific data from a content provider of the wiki. The method further includes receiving, via the communication module, the location-specific data from the content provider and compensating, by a user compensation module, the content provider for the location-specific data.

Another approach is a method for generating a texture map overlay. The method includes receiving, via a database interface module, a map indicative of a geographic location and associating, by a texture layering render module, for at least one sub-region of the map, a texture indicative of the sub-region. The method further includes generating, by the texture layering render module, a map overlay including a respective graphic image indicative of the associated texture.

Any of the approaches described above can include one or more of the following embodiments. In some embodiments, the communication module and the user compensation module are implemented in a machine that comprises instructions stored in a machine-readable medium and a processor that executes the instructions.

In other embodiments, the method further includes storing the modified contributor account on a storage device. The method further includes the determining the compensation amount based on the content contribution request and a request category.

In some embodiments, the method further includes identifying, by the user collaboration module, a content data in the content contribution request and storing the content data in a storage device.

In other embodiments, the method further includes posting the stored content data on a wiki, the wiki is a geographically organized wiki.

In some embodiments, the method further includes reviewing the stored content data via a user interface and posting, via the communication module, the stored content data on a wiki.

In other embodiments, the method further includes compensating, by the user compensation module, a reviewer for the reviewing the stored content data.

In some embodiments, wherein the compensation amount includes a plurality of points.

In other embodiments, the method further includes providing cash to a contributor associated with the contributor account in exchange for the plurality of points.

In some embodiments, wherein the content contribution request is geographic-location specific.

In other embodiments, the method further includes triggering the compensation amount for the content contribution request based on a location of the client device.

In some embodiments, wherein, in the act of triggering, the location of the client device is a retailer and the content contribution request is a price of a product at the retailer.

In other embodiments, the method further includes compensating, via a user compensation module, the contributor for the content contribution.

In some embodiments, wherein, in the act of triggering, the content contribution is a fuel price.

In other embodiments, wherein in the act of triggering, providing a plurality of nearby locations to enable the contributor to specify the location of the content contributor.

In some embodiments, wherein the user collaboration module is implemented in a machine that comprises instructions stored in a machine-readable medium and a processor that executes the instructions.

In other embodiments, the system further includes a storage device to store the modified contributor account.

In some embodiments, the system further includes a user collaboration module to post a content data to a wiki.

In other embodiments, wherein the wiki is a geographically organized wiki.

In some embodiments, the system further includes a user collaboration module to review the content contribution request.

In other embodiments, the system further includes a second compensating module to compensate a reviewer for the act of reviewing.

In some embodiments, wherein the first compensating module provides the compensation in the form of a plurality of points.

In other embodiments, wherein the first compensating module provides the compensation in the form of cash to the contributor.

In some embodiments, wherein the content contribution request received by the communication module is geographic-location specific.

In other embodiments, the system further includes a user collaboration module to trigger the contributor for the content contribution request based on a location of the user device.

In some embodiments, wherein the user device is a GPS-enabled phone.

In other embodiments, wherein the user collaboration module is configured to identify the location of the content contributor as a retailer and request the content contribution of a price of a product at the retailer.

In some embodiments, the system further includes a user compensation module to compensate the contributor for the content contribution.

In other embodiments, wherein, the user collaboration module is configured to request the content contribution of a fuel price.

In some embodiments, wherein, the user collaboration module is configured to provide a plurality of nearby locations and the communication module is configured to receive a choice from the plurality of nearby locations, thereby specifying the location of the content contributor.

In other embodiments, wherein the user collaboration module provides the plurality of nearby locations in the form of retailer names.

In some embodiments, wherein the act of receiving involves receiving the location information from a GPS-enabled device associated with the user.

In other embodiments, the method further includes posting the traffic information to a geographically organized wiki, the user being associated with the wiki.

In some embodiments, the method further includes in the act of compensating, providing a greater compensation value depending on a type of request.

In other embodiments, the method further includes in the act of compensating, providing a greater compensation value depending on a value associated with fulfilling the request.

In some embodiments, the method further includes receiving an indication from the content provider that the content provider intends to provide the location-specific data; and reserving for a limited time, for the content provider, an opportunity to respond to the act of soliciting.

In other embodiments, the method further includes in the act of requesting, requesting only content providers proximate to the location.

In some embodiments, the method further includes in the act of receiving a request, collecting a credit card number to enable charging the credit card for the location-specific data.

In other embodiments, the method further includes providing the location-specific data to a source of the request.

In some embodiments, the method further includes billing the source of the request for the location-specific data.

In other embodiments, the method further includes wherein, in the act of receiving a request for a location-specific data capture, the location-specific data is at least one photograph of real property.

In some embodiments, wherein the texture is a photo-realistic image.

In some embodiments, wherein the photo-realistic image is scalable.

In other embodiments, wherein the texture is selected from a plurality of different textures able to render items found in a landscape.

In some embodiments, the method further includes further comprising varying opacity of the map overlay.

In other embodiments, the method of any of the above approaches and/or embodiments can implemented in a machine that comprises instructions stored in a machine-readable medium and a processor that executes the instructions.

The contributor compensation techniques described herein can provide one or more of the advantages as described herein.

Other aspects and advantages of the present invention can become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, can be more fully understood from the following description of various embodiments, when read together with the accompanying drawings.

FIG. 1 illustrates a block diagram of an exemplary system;

FIG. 2 illustrates a block diagram of an exemplary atlas server;

FIG. 3 illustrates a schematic diagram of an exemplary user interface;

FIG. 4A illustrates an exemplary satellite imagery layer;

FIG. 4B illustrates an exemplary textured layer;

FIG. 5 illustrates another exemplary textured layer;

FIG. 6 illustrates an exemplary roadway texture;

FIG. 7 illustrates another exemplary roadway texture with an increased zoom;

FIG. 8 illustrates an exemplary selection of textures;

FIGS. 9A-9C illustrate exemplary screenshots of an exemplary user interface of the system;

FIG. 10 illustrates another exemplary screenshot of another exemplary user interface of the system;

FIG. 11 illustrates an exemplary flow diagram of the contributor compensation system;

FIG. 12 illustrates another exemplary flow diagram of the contributor compensation system;

FIG. 13 illustrates another exemplary flow diagram of the contributor compensation system;

FIG. 14 illustrates another exemplary flow diagram of the contributor compensation system; and

FIG. 15 illustrates another exemplary flow diagram of the contributor compensation system.

### DETAILED DESCRIPTION

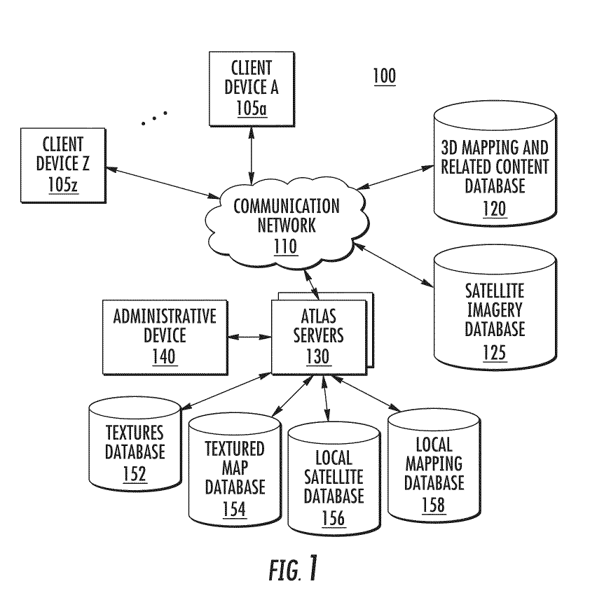

FIG. 1 illustrates a block diagram of an exemplary system 100. The system 100 includes a plurality of client devices A 105a through Z 105z (generally referred to as the client device 105), a communication network 105, a 3D mapping and related content database 120, a satellite imagery database 125, one or more Atlas servers 130 (e.g., Intel-based LINUX servers, personal computers, etc.), an administrative device 140, a textures database 152, a textured map database 154, a local satellite database 156, and a local mapping database 158.

The atlas servers 130 communication with the textures database 152, the textured map database 154, the local satellite database 156, the local mapping database 158, the 3D mapping and related content database 120, and/or the satellite imagery database 125 to utilize stored information. The atlas servers 130 utilize the stored information in the generation of content for a user interface (e.g., web based user interface, downloaded java applet, locally installed client application, etc.). The stored information may include one or more of satellite imagery, maps (e.g., roads, geographic features, defined boarders/boundaries, such as national, state, county, and municipal boundaries, residence, business maps, etc.), and other information. In particular, the stored information may include one or more texture maps and/or texture files. One or more of the stored information sources may be stored in a database, accessible through a database system (e.g., the textures database 152, the 3D mapping and related content database 120, etc.).

The administrator device 140 may provide management of the atlas server 130, the stored content, advertisements (e.g., stored in a local storage device, stored in a remote database, etc.), value point systems, and the like.

The atlas servers 130 are also connected to one or more users through the communications network 110. The users utilize the client device 105 to access the user interface provided by the atlas servers 130. For example, the atlas servers 130 are connected to client devices 105 communicate via the World Wide Web (Web) over the Internet.

In some embodiments, the client devices 105 access content and features as HTML pages served by the atlas servers 130. Some users are mere consumers of content, whereas other users who may also be consumers are content providers. Thus, generation and management of the content may be accomplished locally through the administrative device 140 and/or remotely through Web accessible content providers. The content, such as maps, satellite imagery, residential and business information, may be obtained from third party sources, such as commercial databases, municipalities, etc.

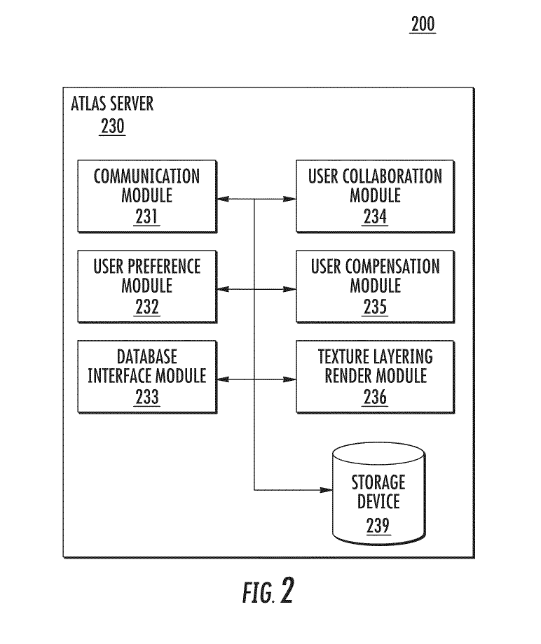

FIG. 2 illustrates a block diagram of an exemplary atlas server 230. The atlas server 230 includes a communication module 231, a user preference module 232, a database interface module 233, a user collaboration module 234, a user compensation module 235, a texture layering render module 236, and a storage device 239. The communication module 231 receives and/or transmits communication the different components of the system 100 (e.g., client device 105, the administrative device 140, etc.). The user preference module 232 processes, stores, and/or retrieves user preferences associated with each user. The database interface module 233 processes, stores, and/or retrieves the stored information via the databases (e.g., the local mapping database 158, the satellite imagery database 125, etc.).

The user collaboration module 234 receives a content contribution request from the client device 105 of FIG. 1. The user collaboration module 234 may further process the request and identify the content data in the content contribution request (e.g., location of bricks in an layer, name of business at a location, picture of house at another location, etc.). The user collaboration module 234 may further transmit the identified content data on the storage device 239.

The user compensation module 235 determines a compensation amount (e.g., ten dollars, five credits, etc.) based on the content contribution request (e.g., email with content data, web upload with content data, etc.). The user compensation module 235 may then modify the user's account based on the determined compensation amount (e.g., credit account ten credits, debit account five cents, etc.). The texture layering render module 236 processes and/or renders layers for viewing by the user. The storage device 239 stores the content data, the layers, the user preferences, the content contribution request, the compensation amount, the user's account, and/or any other data associated with the content contribution.

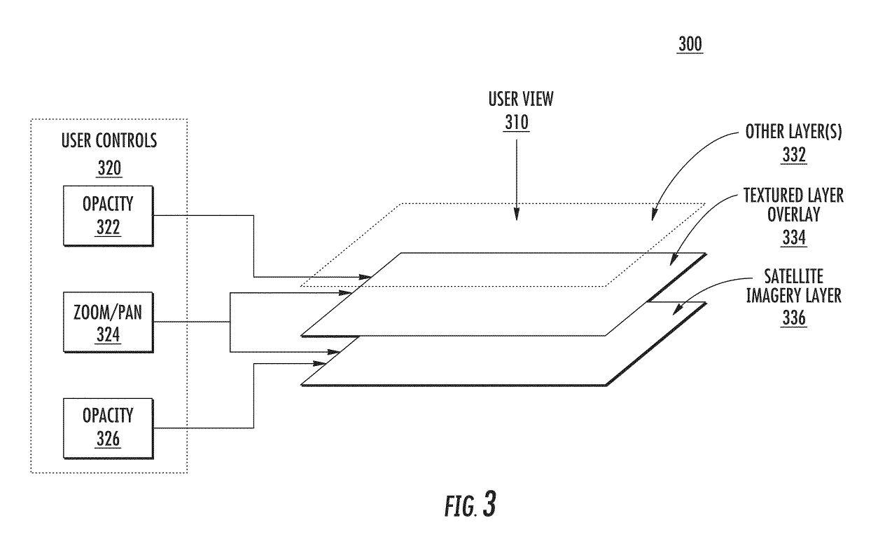

FIG. 3 illustrates a schematic diagram of an exemplary user interface 300. The user interface 300 includes user controls 320 and a user view 310. The user controls 320 include a first opacity 322, zoom/pan 324, and a second opacity 326. The user view 310 includes other layers 332, textured layer overlay 334, and satellite imagery layer 336.

In some examples, HTML pages can be prepared as one or more layers (e.g., the textured layer overlay 334, the satellite imagery layer 336, etc.), and presented to a Web client (e.g., via the client device 105). The user may also be presented with one or more tools for accessing, navigating, and in some instances manipulating the data content (e.g., the user controls 320). For example, a user requests a map of a particular geographic region (e.g., One Main Street, Boston, Mass., Back Bay, Boston, Mass.). The atlas server 130 obtains satellite imagery of the requested region (e.g., via a request from the database interface module 233 of FIG. 2 to the satellite imagery database 125 of FIG. 1, via a request from the database interface module 233 to the local satellite database 156, etc.) and provides a graphical representation of this imagery in the satellite imagery layer 336. The atlas server 130 may also obtain other information related to the requested geographic region, such as a texture layer (e.g., displayed via the textured layer overlay 334), road map layer (e.g., displayed via the other layer 332), advertisement layer (e.g., displayed via the other layer 332), etc.

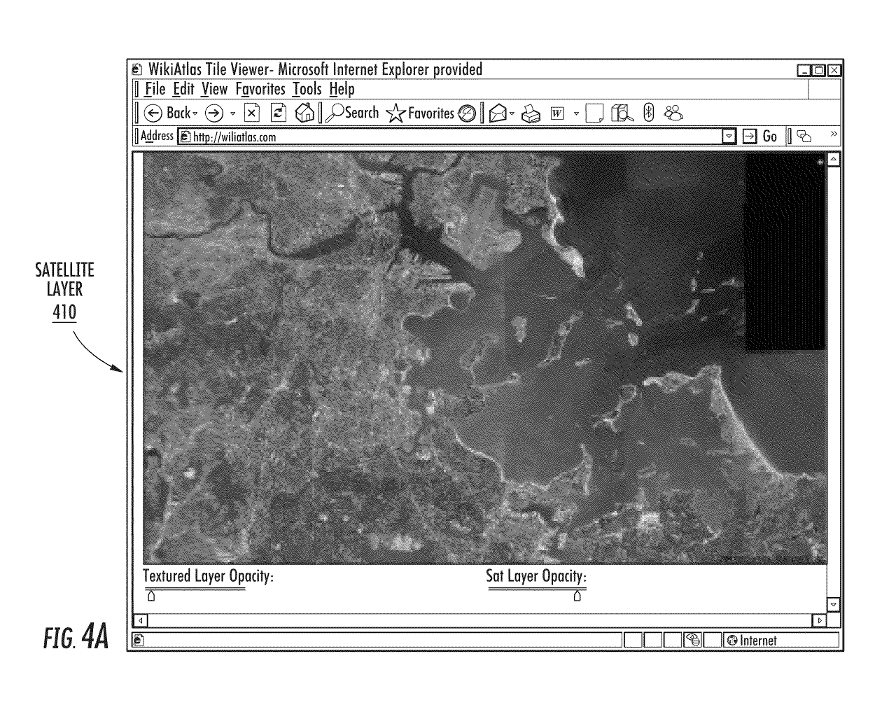

FIG. 4A illustrates an exemplary satellite imagery layer 410. FIG. 4B illustrates an exemplary textured layer 420. A Web user views one or more of the layers (e.g., 410 and/or 420) for the requested geographic location. The layers may be stacked as overlays as illustrated in FIG. 3.

In some embodiments, the opacity of one or more of the layers is controllable by a user to adjust and readjust the served content in real time (e.g., via the opacity controls 322 and/or 326). Exemplary user controls show separate opacity controllers 322 and 326 for each of the first two layers. In some embodiments, the user is provided with a single slider to control the relative opacity of two or more layers. Alternatively or in addition, the user is provided with additional controls, such as a pan and zoom 324, to allow the user to adjust a requested location graphically. The atlas server 130 may generate updated HTML pages in response to user manipulation of the pan and zoom controls 324.

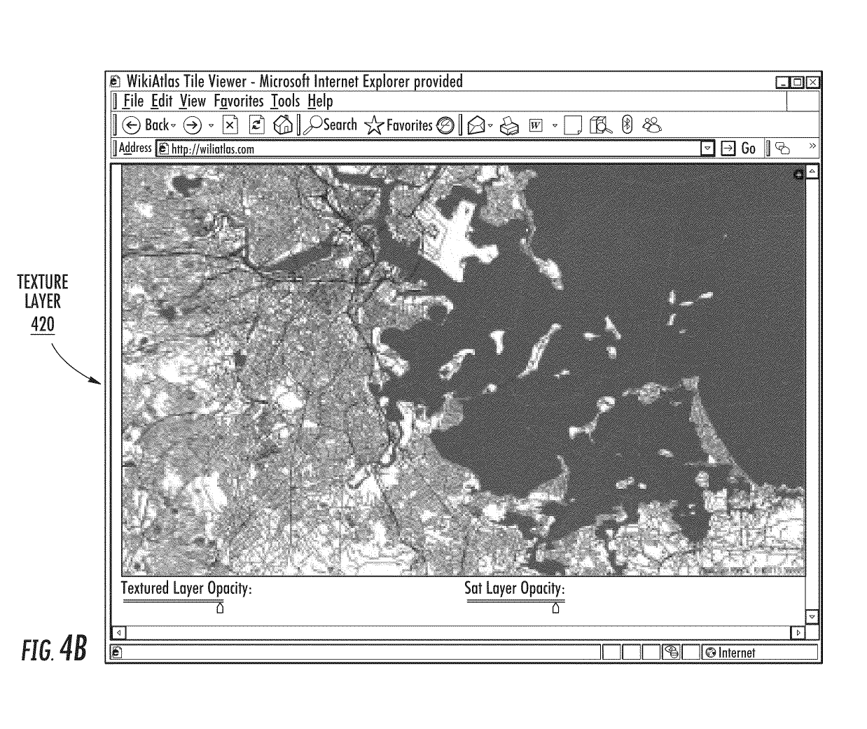

FIG. 5 illustrates another exemplary textured layer 500. In some embodiments, the texture layer 500 provides a texture for one or more sub regions of the requested geographic region. The texture layer 500 provides one or more textured regions associated with geo-locations. The textured regions include a roadway 512, water 514, a railway 516, and/or a non-textured region 518 (i.e., textured region in the form of a non-textured region). Boundaries of the textured regions may obtain from one or more of geographical maps, road maps, rail maps, waterway maps, user-provided information, residential and business information, municipal information (e.g., tax records, registry of deeds). The opacity of the texture layer may be controlled via a texture layer opacity control 520. The opacity of the satellite layer may be controlled via a satellite layer opacity control 522.

In other embodiments, a texture associated with the region bears some relationship to the actual region. In the illustrative example, a water texture is included in the textured layer for water 514 identified from a geographic map. A different texture, such as the sand or gravel colored texture, may be associated with a boundary between water and land. Similarly, roadway and railway textures 512 and 516, respectively, may be included at the appropriate locations of any roadways and railways determined from one or more suitable maps.

Texture layer and satellite layer opacity controllers 520 and 522, respectively, are illustrated in the textured layer 500. In the exemplary embodiment, the opacities are maximized, but only the textured layer is observable as it had been prepared as an overlay to the satellite imagery layer. As the opacity of the top layer (i.e., the textured layer) is reduced, one or more underlying layers may become visible. Such a feature can be used by content providers in combination with a polygon generation tool to define sub regions and to apply textures to the regions determined from one or more of the lower layers. Also observable in white are non-textured regions that have not yet been associated with any textures. In some embodiments, a default texture can be used for undefined regions. Alternatively or in addition, sub-regions can be refined adding additional sub-regions and/or textures as resources allow. Any regions may also be re-defined as may be necessary due to changes in the underlying information (re-defined property plot lines, new roadways, etc.).

In other embodiments, the textures may be provided as computer-generated graphics, photographs, or a combination thereof. In some embodiments, the textures are generated as photorealistic graphical images. The generated texture images can be stored in an image dictionary (e.g., a database, a storage device, etc.). The texture images can be associated with a feature indicative of a geographical location, landscape, structure, etc.

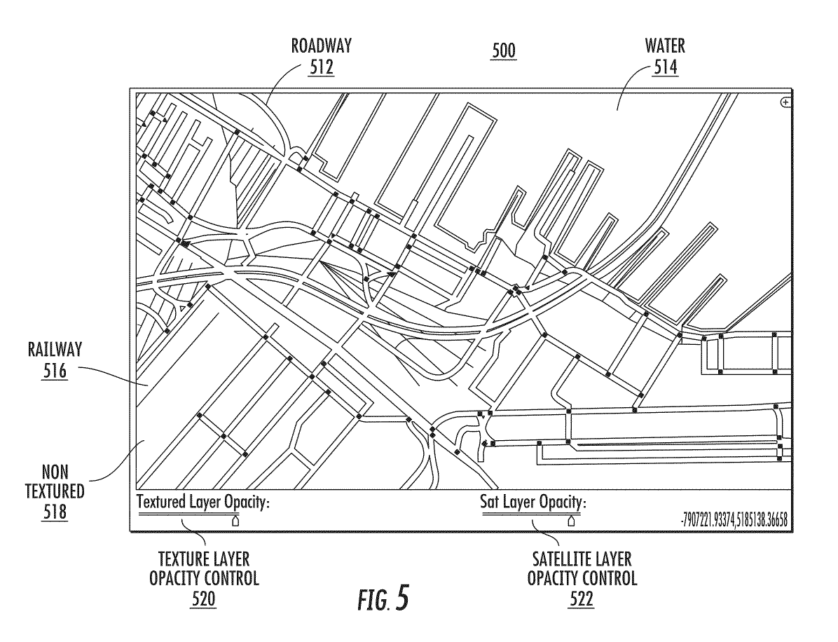

FIG. 6 illustrates an exemplary roadway texture 600. The roadway texture 600 includes a highway 610, a roadway detail 612, a railway 614, gravel 616, and earth 618. The roadway texture 600 may be stored as a roadway texture image on a storage device (e.g., the storage device 239 of FIG. 2) and/or a database (e.g., the textures database 152). The stored image can then be associated with a highway. Thus, for geo-locations related to a highway, the appropriate texture is selected from the texture dictionary and associated with a corresponding region of a texture layer corresponding to placement of the roadway. The pre-stored texture image may include features, such as the lane markings of the roadway. The textured images can be prepared such that when arranged next to each other within a texture layer they form a sensible image of the underlying geographical feature. Thus, only a portion of a roadway need be stored, such as a strip of multilane roadway that can be properly oriented according to a roadway direction and repeated in sequence along the roadway to provide an assembled image of the road.

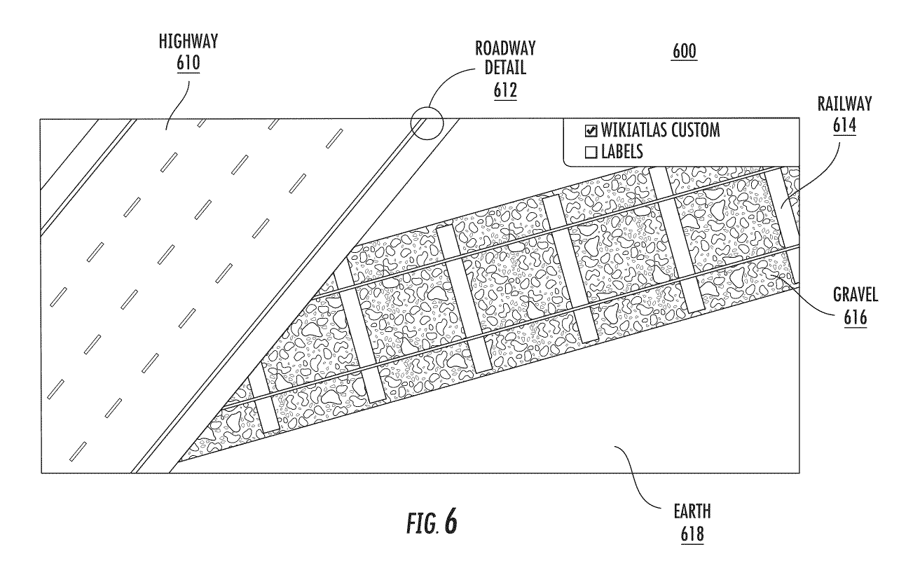

FIG. 7 illustrates another exemplary roadway texture 700 with an increased zoom. The roadway texture 700 includes a roadway detail 710, a pan control 712, and a zoom control 714. In some embodiments, the textured images are scalable, to provide photo-realistic images at different zooms. The roadway detail 613 of FIG. 6 can be reproduced at an increased zoom or magnification as illustrated in the roadway detail 710 of FIG. 7.

In some embodiments, the textured images themselves are scalable. Alternatively or in addition, different textured images are provided for different zooms, or ranges of zooms. In the exemplary embodiment, the roadway detail 710 of FIG. 7 may have been obtained from a scaled version of the same image or a different texture image than FIG. 6, selection of the appropriate image depending upon the geo-location and the selected zoom.

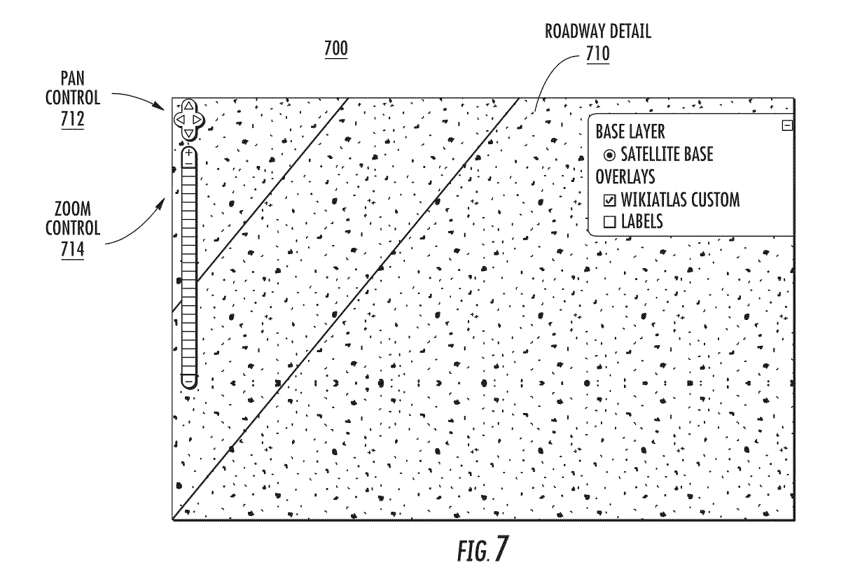

FIG. 8 illustrates an exemplary selection of textures 800. The selection of textures 800 include water 810, grass 812, brick 814, and roof tile 816. In other embodiments, the range of textures is limitless. Practically, however, a texture dictionary can begin with a variety of images suitable to identify a substantial variety of geographic locations. A montage of an exemplary selection of textures 800 is illustrated in FIG. 8. The dictionary can be extended and enhanced.

In some embodiments, a textured layer is generated in association with a geo-location layer, such as a map. The textured layer may be initially blank, in which a content provider identifies sub-regions within the texture layer associated with sub-regions of the geo-location layer. The regions can be delimited by boundaries, and a texture identifier is associated with the identified region. The texture identifier may include a texture available within the texture dictionary (e.g., grasslands, roadway, gravel, water, etc.). Thus, the texture layer includes boundary information and texture descriptors. A texture layer rendering module 236 of FIG. 2 takes the textured images from the texture image dictionary and renders them in a graphical image of the textured layer including the associated textures at the selected sub-regions. The rendered graphical image of the textured layer can be stored for later retrieval via the storage device 239 and/or the database (e.g., the textured map database 154, etc.).

Alternatively or in addition, textures can be associated automatically, based on selected defaults. Examples would include a water texture displayed for bodies of water obtained from maps; a woodland texture obtained from maps of state and national parks; and roadway texture for roadways obtained by roadway maps.

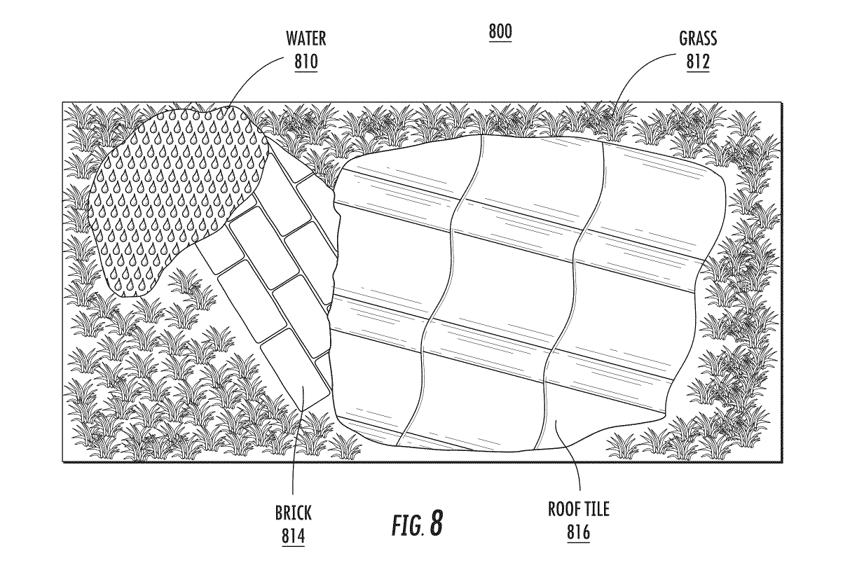

FIGS. 9A-9C illustrate exemplary screenshots of exemplary user interfaces 900a, 900b, and 900c, respectively, (generally referred to as user interface 900) of the system 100 of FIG. 1. The user can utilize the user interface 900 via the client device 105 to transmit a content contribution request 912 (e.g., paint your neighborhood, upload a picture, add bricks, etc.). The user can receive compensation 914 for the content contribution request 912 (e.g., five points for writing an article, ten points for editing a road, etc.). The user can connect 916 with other users by transmitting the content contribution request 912 (e.g., posting a note on an old house, entering a chat room for a location, etc.).

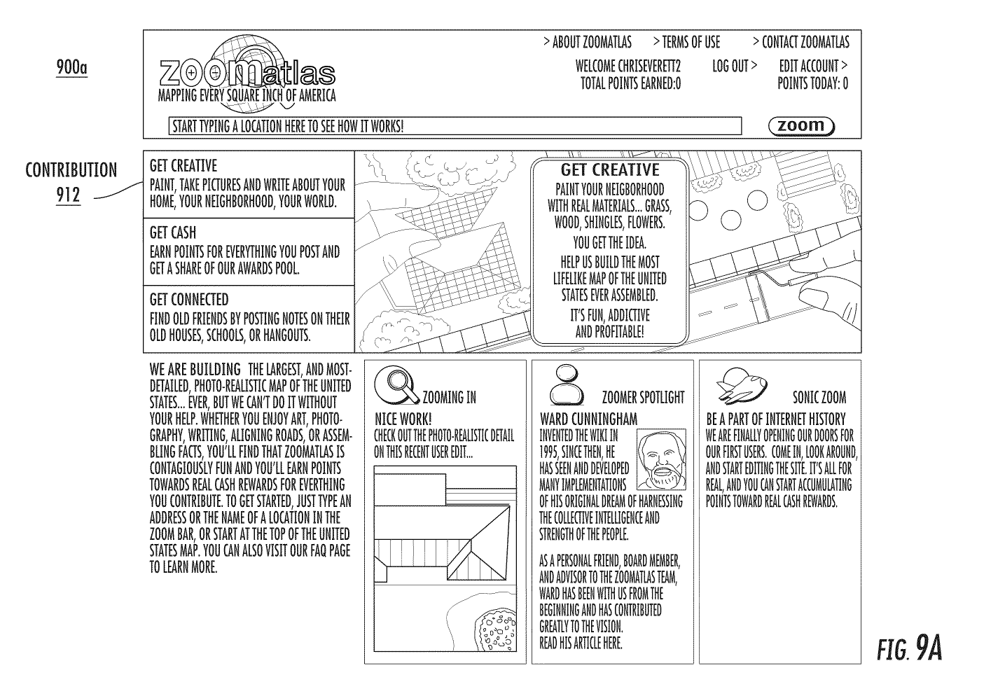

FIG. 10 illustrates another exemplary screenshot of another exemplary user interface 1000 of the system 100 of FIG. 1. The user interface 1000 includes a display of a map 1010, a location 1012, business information 1014, a get connected area 1016, and an advertisement 1018. The user can utilize the user device 105 to utilize the user interface 1000 transmitted via the communication network 110 from the atlas server 130.

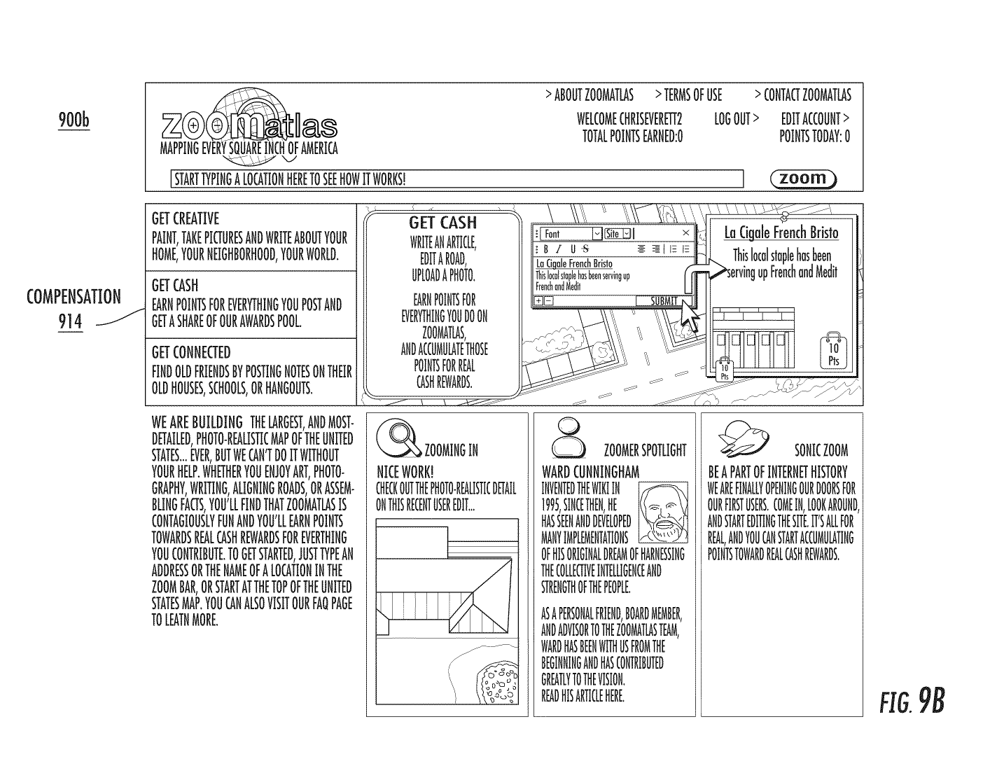

FIG. 11 illustrates an exemplary flow diagram 1100 of the contributor compensation system 200 of FIG. 2. The communication module 231 receives (1110) a content contribution request from a contributor client device (e.g., the client device 105 of FIG. 1). The user compensation module 235 determines (1120) a compensation amount based on the content contribution request. The user compensation module 235 modifies (1130) a contributor account based on the compensation amount. The storage device 239 stores the modified contributor account.

In other embodiments, the user compensation module 235 determines (1120) the compensation amount based on the content contribution request and a request category (e.g., user is at gold level, user is at bronze level, content data is high priority, content data is low quality, etc.).

In some embodiments, the user collaboration module 234 identifies a content data in the content contribution request. The storage device 239 may store the content data.

In other embodiments, the communication module and/or the user compensation module are implemented in a machine that comprises instructions stored in a machine-readable medium and a processor that executes the instructions.

In some embodiments, the modified contributor account (e.g., ten points, four hundred points, etc.) is stored on a storage device (e.g., flash drive, hard drive, network attached storage, etc.).

In other embodiments, the stored content data is posted on a wiki. The wild may be geographically organized wiki. The stored content data may be reviewed via a user interface. The stored content data may be posed on a wiki.

In some embodiments, a reviewer is compensated for the reviewing the stored content data. The compensation amount may include a plurality of points. Cash may be provided to a contributor associated with the contributor account in exchange for the plurality of points. the content contribution request may be geographic-location specific.

In other embodiments, the compensation amount for the content contribution request is triggered based on a location of the client device. The location of the client device may be a retailer and the content contribution request may be a price of a product at the retailer.

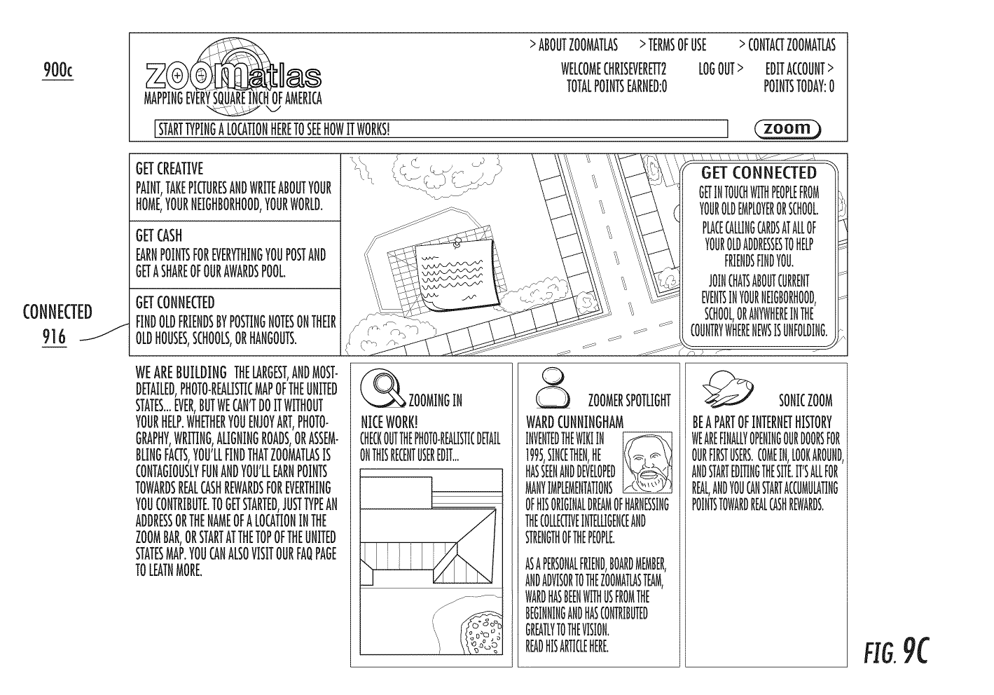

FIG. 12 illustrates another exemplary flow diagram 1200 of the contributor compensation system 200 of FIG. 2. The user collaboration module 234 triggers (1210) a contributor for content contribution to a wiki (e.g., web site that allows editing by the users) based on a location of the content contributor. The user compensation module 235 compensates (1220) the contributor for the content contribution.

In some embodiments, the content contribution is a fuel price. In other embodiments, a plurality of nearby locations is provided to enable the contributor to specify the location of the content contributor.

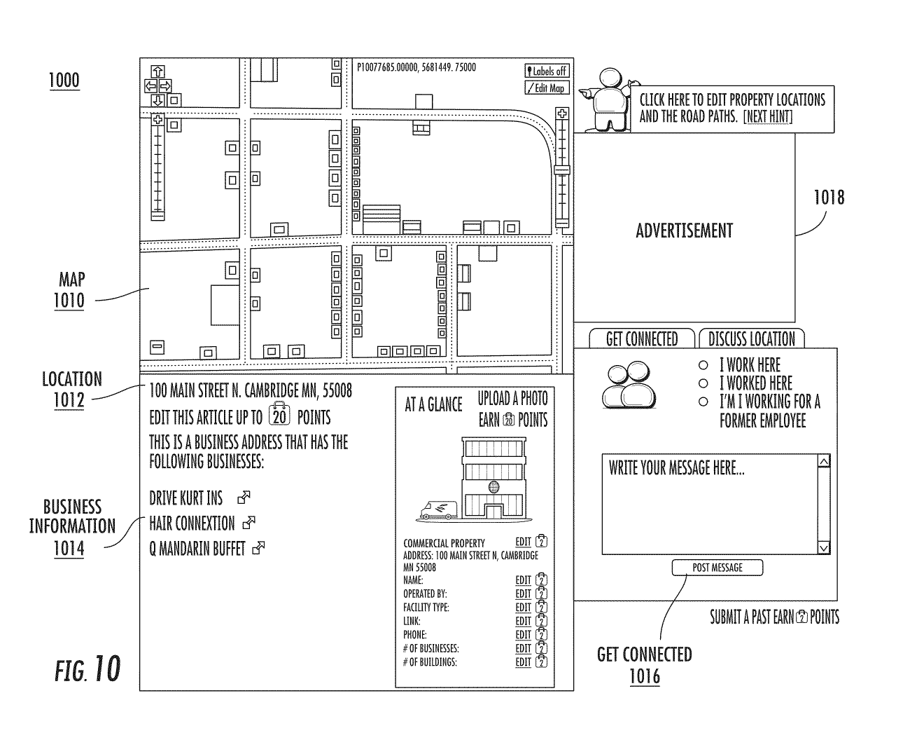

FIG. 13 illustrates another exemplary flow diagram 1300 of the contributor compensation system 200 of FIG. 2. The communication module 231 receives (1310) information regarding at least location information of a user. The user collaboration module determines (1320) traffic condition information proximate to the user by determining a speed of the user from the location information. The user compensation module 235 compensates (1330) the user for providing the location information.

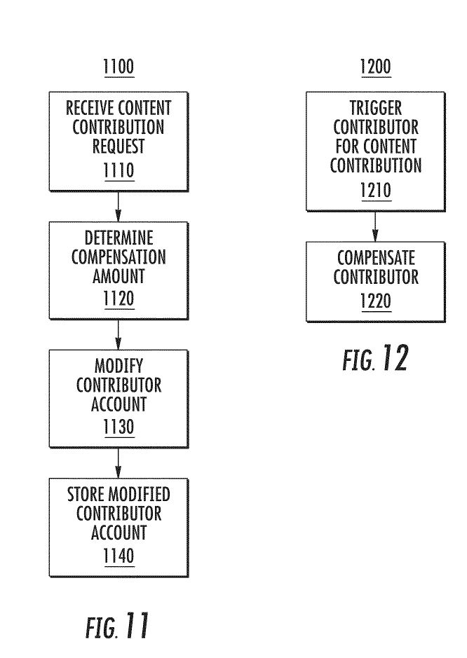

FIG. 14 illustrates another exemplary flow diagram 1400 of the contributor compensation system 200 of FIG. 2. The communication module 231 receives (1410) a request for a location-specific data capture. The database interface module 233 requests (1420) the location-specific data from a content provider of the wiki. The communication module 231 receives (1430) the location-specific data from the content provider. The user compensation module 235 compensates (1440) the content provider for the location-specific data.

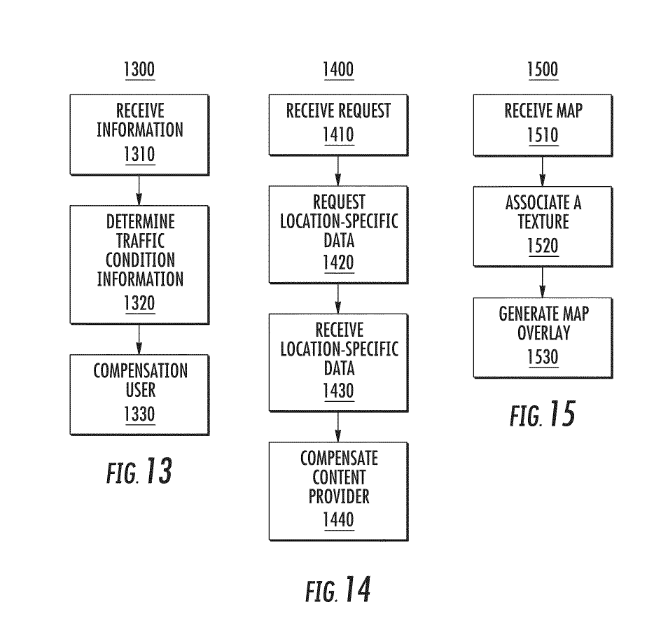

FIG. 15 illustrates another exemplary flow diagram 1500 of the contributor compensation system 200 of FIG. 2. The database interface module 233 receives (1510) a map indicative of a geographic location. The texture layering render module 236 associates (1520) for at least one sub-region of the map, a texture indicative of the sub-region. The texture layering render module 236 generates (1530) a map overlay including a respective graphic image indicative of the associated texture.

It is understood that many variations from the illustrative embodiment of the technology is possible within the scope of the description of the system 100 of FIG. 1. The system 100 can include a user generated content website of geographic information. The system 100 can include a huge database containing information about every square foot of the United States and surrounding waterways.

The system 100 can contain information and photographs of every residential and business address in the country. Beyond the typical name, address, and tax information which may exist on sites like Zillow and telephone directory sites, WikiAtlas can contain interior and exterior photographs, descriptions, history, builder names, floorplans, and current contact information of prior residents.

For Retail addresses, the site can offer the standard yellow page information as well as company web site links, product and service offerings, menus, previous occupants, and site history.

Additionally, information about parks, neighborhoods, golf courses, ski areas, undeveloped land, waterways, sports arenas, houses of worship, cemetery plots, schools, government buildings, shopping malls, multi-unit buildings, parking lots, bridges, tunnels, and roadways can all be tagged with photographs, textual descriptions, and historical information.

A large array of tools can be provided for users. One tool can allow users to post notes and start discussion groups associated with any physical geographic location. With this tool, users can be able to locate old friends that lived at a certain address, discuss neighborhood issues, public works projects, fishing spots, holes on their favorite golf course, runs at a ski area, restaurant reviews, and school gossip.

The system 100 can offer a unique twist on a wiki. A Wiki, a term coined by Ward Cunningham from the Hawaiian word for “quick,” includes a web site that is built by its own user base. Wikipedia is the best example of this type of site, where a prolific group of dedicated users have assembled the most complete set of documentation on every subject imaginable.

According to the illustrative embodiment, the individual contributors at the system 100 can receive real value for their efforts. The system 100 can assign points for every contribution of text, data, or photographs, and these points can be converted to compensation. Examples of compensation can include, but are not limited to cash, gift cards, rewards, stock, stock options, phantom stock, coupons, gas credits, pseudo equity, profit sharing, or equity in the Company they are helping to build. The theory is that if Wikipedia was built by individuals who contribute significant hours of their time to writing articles in exchange for a minute amount of recognition buried on a well-hidden page, the site should enjoy significantly more support by contributors.

The system 100 can perform little demographic targeting in the ads they run, thus acquiring site visitors for pennies apiece. By the geographic nature of the site, these same visitors can quickly drill down to geographic areas and businesses and neighborhoods of interest, and can be served high-revenue targeted ads. Since the system 100 contains such a broad range of content, so much information can be gathered about each site visitor and even more valuable ads can be served.

The system 100 can offer a large and unique set of compelling content and tools to educate, challenge, and entertain users of all backgrounds. Its unique approach of affording users the ability to receive compensation for contributions to the system 100 should yield significant interest, viral marketing opportunities, and attention from the press.

The technology of the system 100 is located at the nexus of internet search, geographic applications, community web sites, and online reviews. These are all high profile businesses. As such, the system 100 can be utilized to create the largest searchable database of geographic-specific information, covering every residential, commercial, institutional and public location in the USA (and/or the world).

The system 100 can create and aggregate unique information about every physical location in the United States. This information can include photographs of every structure, key data, web site links, historical information, and/or descriptive text. The system 100 can be initially seeded with purchased data, and the user community can be enticed to provide additional data, photographs and textual content. A rich set of tools and features can be provided to entertain, educate, and assist users in a large variety of endeavors.

Income for the site can be derived from the sale and placement of targeted advertisements within the system 100, in addition to the sale and licensing of site data to third parties. By providing users with a wide array of tools, information, and relevant content, site visitors can visit many pages in the site and return frequently. This can result in significant numbers of page views and proportionately significant ad revenue. Furthermore, since ads are placed based on geography, the revenue per ad can be higher than industry averages. A goal of the system 100 is to build a site which aggregates complete, accurate, and authoritative documentation of every physical location in the United States.

In some embodiments, an objective is to actively recruit content from individual users who sign up as Content Partners (CPs). During the beginning of operation (Phase I), CPs can earn points redeemable for stock options at the end of Phase I. The quantity of points earned by each CP can be determined by the number of new locations added, articles written, data fields edited, and pictures uploaded.

The system 100 can build a large network of individual contributors, known as CPs, who are incentivised to populate the site with information and photographs from their own geographical area. The system 100 can build a large and useful site which maps every location in the country (and/or the world), and ultimately provides useful tools and information to support many different personal and commercial uses. The system 100 can includes a huge web site of over one hundred and thirty million pages of content dedicated to the documentation of every square inch of American soil. The vast majority of the system 100 can consist of millions of pages, each one dedicated to a specific geographic locality, as large as a multi-state region or as small as a single residence or patch of outdoor space. From the home page, site visitors can be able to immediately start their geographic browsing, or enter one of the informational sections which cover Company information, the CP Program, and general site help and information.

Pages in the site can be navigable through a well-defined hierarchy. The actual placement of each HTML file in the system 100 (e.g., the Linux file system) can mimic the navigation hierarchy that the user sees.

The top-level page can be the main USA page which can exist in the /usa directory. From the main USA page, the user may select a region of the country (Northeast, Southwest, etc.) or an individual state. The region pages, of course, can provide access to the states with that region. Every page in the hierarchy can be displayed with a path of links which identify to the user the exact location of the current page, while providing a method for clicking on any higher page in the hierarchy. For example, the page for a particular address can contain a path of links at the top specifying: Country (USA); Region; Sub-Region (if applicable); State; County; City/Town; Zip Code; Section of town (if applicable); Road or street; Block; and/or Building complex, Campus, or Shopping Center (if applicable).

In some embodiments, pages which have no sub-divisions like single family homes, apartments, storefronts, and undeveloped land parcel are called terminal pages. Terminal pages can generally have links to adjacent locations and locations across the street.

A single Zip code sometimes represents a single city or town, but may also represent a section of a city or town, or sometimes spans multiple towns. Therefore, the Zip code in a link path may occur before or after the city/town link.

In addition to the standard hierarchical links described above, users can be able to navigate the site with a smart search function. By typing a location description in the search bar, a user is immediately brought to the desired page. If the search software cannot uniquely distinguish a location from the entered text, the user is brought to a page with a set of possible matches.

The system 100 can include a basic search capability which can recognize locations by the following criteria: Zip code; Airport code; Region, State, County, City name; Street name if included with Zip code or City/State pair; Point of Interest name; Full address with house number; business name with Zip code or City/State pair; and/or a Business Category search by Zip code or City/State pair can display a list of all such businesses, with pictures and satellite imagery, for businesses in the targeted location or nearby.

Points of Interest can are flagged in the database as being “nationally recognizable,” and not require that the user enter city or state information. Examples of these POIs are places like Yosemite National Park, Golden Gate Bridge, Broadway, Washington Monument, and the Alamo. A separate database table of such common searches can be maintained.

A pan and zoom tool can be utilized as an additional site navigation tool. Through a series of enhanced features, the user can be able to overlay “layers” on the map to view specific categories of features like states, counties, zip codes, towns, and individual parcels. With a specific overlay active, the user can be allowed to click on the exact location of interest. For example, with the parcel overlay, a click on the map can take the user directly to the page for that selected property. If the Zip code overlay is selected, the user is brought to the specific Zip code page.

A rich set of Bulletin Board features can be provided. A significant amount of site layout and design efforts can be expended to provide visual cues to the following two aspects: 1. Anyone can post on bulletin boards and forums and 2. Only designated editors can edit the main site data. The only minor exception to the second rule, is that anyone can be allowed to suggest edits and provide photographs for the main site, but that information does not get posted without the approval of a designated editor.

The bulletin board feature can allow users to attach notes to any physical location, including but not limited to: 1. House; 2. Apartment Unit/Condo Unit; 3. Residential Building; 4. Business; 5. Park; 6. Street or Block; 7. Neighborhood; 8. School; 9. Town, City, or Zip Code; 10. Place of Worship; 11. Golf Course or Golf Course Hole; 12. Ski Area or Ski Run; 13. Cemetery or Cemetery Plot; 14. Ballpark or Stadium; 15. District (ex: water, fire, police, electric); 16. Township; 17. County; 18. State; and/or 19. Region.

In other embodiments, a feature of the system 100 is that the types of subjects can be discussed in these geo-centric forums. The possibilities are limitless, but here are just a few:
Neighborhood; Discuss real estate values, recent sales, recent listings; Events—Block parties, school events, garage/yard sales; Discuss crime and safety issues;
Schools; School news and gossip; Field trips; Teachers and faculty; Reconnect with old classmates. (a free competitor to Classmates.com);
Politics; Discuss a candidate within a state or local area; All Locations—But particularly powerful when assigned to residential address; “I Was Here” feature for connecting with old friends; “Looking for lost friend” postings;
Undeveloped Land; Discuss flora and fauna; Discuss hunting at this location; Discuss zoning and land use issues; Hiking and camping;
Parks; Friends-of-the-park;
Cemeteries; Leave a “visitation” note; Connect with friends and family of the deceased;
Public Works Projects; Progress and scope discussions;
Mountains; Discuss ski areas and individual runs; Mountain climbing;
Waterways; Discuss fishing and boating; Snorkeling and diving; Dredging projects;
Golf Courses; Discuss Course and Maintenance; Discuss Individual Holes;
Stadiums/Ballparks; Discuss home team, concerts and upcoming events;
Condominium/Gated Community; Discuss Homeowner's Association issues; Discuss maintenance and security; Discuss resale values;
Retail Businesses; Write a review;
Bars/Restaurants; Write a review; Discuss favorite menu items; Reconnect with someone you met;
Movie Theaters; Discuss a current movie (these bulletin boards link to all theaters running that movie).

In other embodiments, the bulletin board application can be responsible for keeping the site dynamic and interesting. To prevent empty bulletin boards, the system 100 can be programmed to display the “nearest” three or four messages to any location being visited. So that users do not get fatigued by potentially irrelevant messages, a blatantly obvious visual cue can be displayed whenever a user visits the precise location where a note is posted.

A “View Nearby Notes” feature can allow users to view a zoomed-out map of an area with icons marking the exact locations of posted messages. When multiple notes are posted at a single location, the bulletin board can morph from a collection of disparate notes into a full, multithreaded discussion forum.

The same forum application can be used to host a content provider (CP) forum. This forum can be anchored on the site at a specific address of the Company. So that CPs can not have to search for this forum, links can be provided from every page in the CP sub-site.

A National Forum tool can be another optional feature. Similar to the movie forum discussed above, topics of national interest can be attached to multiple locations throughout the country. Discussions about national chain stores can appear at each location, general discussions about skiing can appear at each ski area, and discussions about the Presidential election can appear on each state page. With an election underway, this may be a candidate for an early release of the National Forum tool.

In other embodiments, a special section of the site of the system 100 can be used to recruit new content providers (CPs). This section can show, in significant detail, the vision for the site in the form of fully-populated sample pages.

In some embodiments, an area of the site of the system 100 can allow CPs to discuss with management and each other, all issues related to site mechanics, rules and regulations, the point program, promotions and point awards, quality control and consistency, etc.

There are many complexities to the data structures that describe all content on the site. As a result, there can be numerous editing tools provided to the CPs. The editing tools can include a text editor, an image upload tool, a supplementary navigation data tool, a page creation tool, an area profiling tool, a location search widget, a polygon editing tool, a multi-region selection tool, an image preview tool, a text preview tool, a custom page creator/frame creator, a traffic detector, a gas price monitor, a location-specific data capture, an opensocial platform, a campaign manager, and/or a banner ad designer.

Text Editor—A large quantity of information on the site can be in marked-up text form. The standard Wiki markup language can be utilized to allow CPs to write articles which include bold and italicized text, line breaks and internal and external links. The allowed markup features can be kept to an absolute minimum to provide visual consistency across the site.

Image Upload Tool—CPs can be able to upload photographs either individually or in groups. When uploading multiple photographs along a single street, the CP can be allowed to enter the house number next to each file. An additional feature of this tool can auto-populate all even addresses in a range, then the odd addresses, so the CP can quickly match sequential photographs with the correct addresses. Images uploaded with this tool are automatically down-scaled to defined site standards (if necessary), tagged with the Company copyright, and saved to a storage device (e.g., both high-resolution and low-resolution files).

Supplementary Navigation Data Tool—Provides the CPs with an interface to define off-road vehicular navigational areas like driveways, parking lots, and rights-of-way. It also can be used to define pedestrian walkways and footpaths for parks, campuses and all other properties.

Page Creation Tool—This tool allows for the creation of a new page to describe any place that is not currently in the database. In addition to specifying the geographic area spanned by this location (see Polygon Editing Tool and Multi-Region Selection Tool), the CP assigns a name and a category for the place. The category is very important since each category has a unique set of data associated with it.

The page types that can be created by CPs include, but are not limited to: Region or Section—Can span political boundaries; District—Fire, School, Police; School Boundary—Elementary, Jr. High, Middle School, High School; Bus Zone, Walk Zone; Utility Service Zone—Water, Sewer, Gas, Electric, Cable, Telephone; Political Boundary—Congressional district, voting precincts; Zip+4; Area Code Zone; Township; Parish; Neighborhood—Can span political boundaries; Residential Building; Residential High Rise—May include profile view; Residential Unit; Commercial Address; Commercial High Rise—May include profile view; Point of Interest; Undeveloped Tract; Water Feature; Parking Lot/Parking Structure; Park; Beach; Ski Area; Golf Course; Cemetery; and/or Government Land

The page types that can be created by Company employees include, but are not limited to: State; County; City/Town; Zip; Section—Can span political boundaries; Street; Block; and/or Block Side (odd/even).

Area Profiling Tool—A powerful component of system 100 is its ability to show customized views of any location. To accomplish this, a rich set of profiling data can be collected in a standardized format. Locations as large as states and as small as individual residential and commercial properties can have demographic checklists that are edited by CPs. A CP can receive a set number of points for editing a checklist.

Location Search Widget—A smart text search field can be displayed on most pages in the site. The text field is connected with the atlas server, and displays completion selection lists. This tool can be tuned for individual addresses, street names, location names, points of interest, and business names. The back-end of this tool can consist of 36 very large indexed database tables (one each for the digits 0-9 and the letters a-z).

Polygon Editing Tool—The identification of geographical areas as small as housing lots or cemetery plots, and as large as multi-state regions, is accomplished with the same tool. The Polygon Editing Tool lets the CP display a map or satellite image of the desired area and, by selecting points, the CP can draw the outline of the new area. The Polygon Editing Tool is used in conjunction with the Page Creation Tool.

Multi-Region Selection Tool—An alternative method for creating a region is by using the Multi-Region Selection Tool to choose which sub-areas make up the new area. For example, to create a water management district, the Multi-Region Selection Tool can be utilized to select the specific counties contained in the district.

Image Preview Tool—Thumbnail-sized versions of pictures uploaded to the site may be displayed on a series of pages which are only visible to a site Administrator. This allows the Administrator to quickly scan for inappropriate image content. For example, next to each image is a link to quickly “pull” the objectionable content and take further action against the contributor.

Text Preview Tool—Text entries by non-registered users and three-star and less CPs can get displayed on the Text Preview Tool. Although software can screen for certain objectionable and abusive content, entries which pass the auto-screening process can still need to be approved by an Administrator, who can have the ability to remove the offensive material and take further action.

Four- and five-star CPs can be allowed to stand-in as Administrators in exchange for points. The points can be awarded on a per-entry basis, with per-hour minimums guaranteed for CPs willing to stay awake during the wee hours of the morning.

Custom page creator/frame creator—An author of a news article on another site can create a publicly-viewable, custom page. For example, if the author is writing about a holdup at a bank, the author first chooses the page for the bank address or block. He then uses simple editing tools to draw colored objects (lines, arrows, circles, text, etc.) on the map and/or satellite image to show where and how the story unfolded. He can write captions for the pictures, and full-text articles complete with links to other sites or site pages. He may also create a simple frame with one or two of these marked-up images and a caption. The author is then provided a block of HTML which he may insert on his own page. Any content that is served from the site is automatically tagged with Company branding and copyright notice and a link back to the custom page.

Traffic Detector—A client application which uses GPS coordinates to calculate a vehicle's speed and location on major highways. This information can be automatically uploaded to the web site, so that average traffic speed can be calculated. This information can be sold to GPS service providers as a nationwide real-time traffic monitor. The information can also be displayed on the site. CPs can receive points for every hour of highway travel while logged on to an approved device. If the universe of CPs grows to a significant level, these incremental data points can be either sold directly to third party or aggregated and sold privately to the GPS service providers as a competing product.

Gas Price Monitor—When a CP's phone is determined to be located at a gas station, an application can automatically launch where the member can enter the current gas prices at that station. This information is automatically used to update the site and can be offered for sale to the GPS service providers. This information can also be sent to the Company from registered phones via an instant message (IM).

In one example implementation, a GPS-enabled phone is used in order to provide CP phone position information. A third-party company can be used as a wholesale distributor to aggregate this information.

Utilizing a large army of CPs to monitor gas prices, the gas price information can be a valuable category of proprietary data. Since the CPs are rewarded, the gas price information can be up to date and accurate.

Location-Specific Data Capture—A third party, such as a customer with a pre-existing relationship, or a new, one-time customer, can submit a request for a location-specific data capture. In one example, the location-specific data may be one or more photographs of real property at the location. In another example, CPs may be solicited to obtain the location-specific data, such as by a specific message to the CP, or by an indication in the wiki. Optionally, only CPs close to the location may be solicited.

In one implementation, the opportunity for a CP to reserve, for a limited time, the opportunity to obtain the location-specific data may be provided. This allows a CP to indicate their desire to fulfill the request, travel to the location, obtain the location-specific data, such as by taking a photograph or noting information available at the location, such as property condition, utility meter information, obtaining an answer to a question from an occupant of the property or a person at the location, or any other location-specific information, and submitting the location-specific information.

In one example, an hour may be reserved in order to submit the information, although other time limits may be determined, optionally based on the timeframe of the request from the third party. CPs may be compensated for responding to the solicitation at a higher level of compensation than compensation associated with a typical wiki content contribution not associated with a location-specific data request. The higher compensation may be determined based on a value of third party payment associated with fulfilling the request from the third party.

In some implementations, the third party may be a mortgage lender, a bank, an owner of a pool of troubled mortgages, a title insurance company, a real estate agent, a property owner, a prospective buyer of a property, another CP, or a user of the wiki.

OpenSocial Platform—OpenSocial is the name of an industry effort to allow application developers the ability to build unique tools for members of the two largest social networks: Facebook and MySpace. It is anticipated that the Company can develop a unique set of tools which allow users to post messages at geographic locations which are only visible to members of their invited social community. Additionally, members' GBS-enabled phones can post their current location for their friends to monitor. Members of the community can know whether the others are at the pizza place, the movies, or a friend's house.

Campaign Manager—This tool can allow advertisers to design text-only ads and specify targeted ad-placement criteria including geographic targeting and page-type targeting. The advertiser can easily set up ad budgets and run dates, and pay by credit card. New ads may get launched immediately.

Banner Ad Designer—A library of attractive blank templates for the most common advertising categories can be provided, along with a tool for adding company-specific text. The constructed banner ads can get immediately imported into the Campaign Manager.

The system 100 can derive its income from the sale of advertising services and the sale and licensing of its proprietary data. The leverage in the financial model comes from the spread between general ad CPMs and targeted ad CPMs. CPM stands for “Cost Per 1000” and is the measurement of the amount of money an advertiser may pay to show their ad 1000 times. When an advertiser does not care where his ad can appear, he typically pays $2 CPM or less. This is a great way to advertise products or services of general interest (i.e., —all ages, genders, SESs, and locations). Other companies, however, need to target specific locations, demographics, or subjects (keywords). Internet ad rates for targeted advertising ranges from $3 CPM to over $100 CPM, depending on the degree of targeting and supply/demand market factors.

The site provides non-targeted advertising campaigns to site visitors, and those users that quickly drill-down to their location of interest are shown high-cost, geographically-targeted ads.

Additionally, by using certain tools on the site, users can effectively build a profile which includes previous and current schools, residences, places of employment, and businesses frequented. Through this rich set of information, the system 100 can quickly learn each user's current demographic profile including their socio-economic history. This information can be utilized to target customers far more effectively.

Wherever possible, the system 100 can sell ad campaigns directly to the advertiser. A simple form can be provided to set up ads using a credit card. The advertiser can choose geography and other qualifications (residential only, commercial only, etc.) for their ad, and set up a budget which gets immediately charged to the credit card. It has not been determined whether to charge cost-per-click or cost-per-impression.

In addition to geo-targeting, national advertisers can be able to place ads across the country on locations that may be of interest to their target market. Some examples include:

| Advertiser | Ad Location |
|---|---|
| Automobile Manufacturers | Car Dealerships |
| Beer and Spirits Company | Bars and Nightclubs |
| Christian Book Publisher | Churches |
| Golf Equipment | Golf Courses |
| National Restaurant Chain | Restaurants |
| Ski Equipment | Ski Areas |
| Teen Fashions | Schools |

In the absence of directly-sold ads, Google and/or Doubleclick ads can be placed in every unsold ad slot. These ads can be called from the third-party server. In the case of Google, the Company can receive a portion of the ad revenue directly from Google. Though Google ads can generate less revenue than self-sold ads, they offer the company an immediate stream of revenue and the guarantee that a targeted paying ad can run in every slot.

The system 100 may track user behavior for the purpose of collecting sophisticated demographic information about each site visitor This can be performed within the constraints of site “cookies,” the site's published Terms of Service statement, and general privacy restrictions. This information can be used to more-intelligently serve ads targeting specific demographics. Like the geo-targeted ad campaigns, advertisers can have the ability to specify their demographic target group directly from the online ad purchasing software.

With the proliferation of geo-specific devices and services, demand for location-specific data has never been greater. The Company can retain the nonexclusive rights to all uploaded photos, data, and text. Additionally, the Company can retain the rights to edits, additions, deletions, and corrections made to data sets purchased or licensed by the Company from third parties (Company Incremental Data). This information may include edits made to third party mapping data and residential and commercial data. Both Company Proprietary Data and Company Incremental Data can be made available to handheld device manufacturers, application developers, site developers, real estate professionals, and other entities for a licensing fee. Additionally, Company Incremental Data can be offered back to the original third party data vendors for sale or barter.

If a significant number of users identify their current home and work location, and agree to receive occasional “offers” in exchange for points, the company could assemble a valuable mailing list. This would be made available for both online email marketers and direct mail marketers. With geo-coding and user profiling, the value of this list could be significant.

With its unique set of tools and information, the Company expects to tap into both the local advertising market (retail businesses, Realtors, and other service providers tied to a specific geographic area) and the social network market (lifestyle brands, dating services, employment services, and other demographically targeted advertisers).

The Company can derive the majority of its revenue from advertising sales. These ads can fall into two broad categories: geo-targeted local ads and category-targeted national ads.

The Company's local advertising options offer a tremendously powerful method of targeting a specific market. Advertisers can easily select geographic regions for their ads in a manner similar to the offline ad venues they currently use. Advertisers can restrict their ads to run only on residential or business addresses. Advertisers may specifically run their ads on competitors' locations or based on specific keywords. Advertisers can address local demographics by placing their ads on local schools, houses of worship, cemeteries, parks and recreation venues, bars, or restaurants. Immediate launch of ad campaigns gives the advertiser the instant gratification of seeing what he just purchased.

By offering a simple, non-threatening form to immediately launch an ad campaign, the Company can lower the intimidation factor most local advertisers experience when using other on-line advertising interfaces. Also, by using CPs as local sales reps, the Company should succeed in introducing these advertisers to the power of local online advertising. Finally, many CPs can actually be Realtors or operate a local business, and they can directly receive points for placing their own ad.

The Company can offer innovative targeting methods for national brands. Geographic regions of any size and composition can be selected. Advertisers can run their ads on locations frequented by their target market. Sophisticated profiling of user behavior can allow for finer targeting opportunities. A sophisticated ad campaign setup tool can be provided for national advertisers to tailor an ad campaign themselves. All self-posted ads can run immediately.

Advertising rates can be constantly tuned to ensure maximum value for the advertiser and profitability for the Company.

Company-sold, local advertising customers can be consumer-oriented businesses serving specific geographic areas. This would include restaurants, retail stores, household services, and Realtors. Advertisers can be able to select the geography and, optionally, a keyword list for their ad placement. The keyword feature has the benefit of allowing advertisers to place their ad on many locations in town that may attract the targeted customer base. For example, a car dealer advertising in their city with the ‘automobile’ and ‘car’ keywords, can have their ad served whenever a user visits the page of any car dealer, mechanic, or body shop in town. If an advertiser wishes to hand-pick ad locations, he could actually place his ad on the page of a competitor. A premium can be charged for exclusive “ad parking.”

The ad software can include user tracking Based on pages visited and the types and locations of posted messages, the site can make certain assumptions about each user's age, gender, income, and interests. Based on this information, demographic targeting can be possible, allowing for the direct sale of national advertising campaigns. Since the site can contain many different features from social networking to information about retirement homes and cemeteries, the site can be interesting to all Americans, regardless of age, gender, or other demographic traits.

The incentivisation of the content providers (CPs) is one aspect of the illustrative embodiment of the invention. A staggering amount of data is needed to make the web site compelling. Most of this data does not exist beyond the minds of the millions of Americans who live and work in each community. Wikipedia has proven that little motivation is needed to get people to write extensive amounts of information about the subjects they know. The offer of compensation in exchange for content can effectively lock-in the loyalty of the majority of contributors.

One optional aspect of the illustrative embodiment of the site is the promotion of the “reconnect with a friend” features. The site can provide enough data to allow users to identify, and post messages on their old homes and those of their friends. They can be able to post messages on schools and former places of employment.

As the site gets built with articles, links, and photos, many of the other features can become more useful. At that point, the Company can begin to promote the general yellow page features, neighborhood browsing, and discussion forums.

The nature of the site and the CP program lends itself to many different free and low-cost viral marketing opportunities. Point bonuses can be awarded to CPs for referring new users. A tiered structure of point bonuses can be designed for the most prolific referrers and for the highest quality referrals. To reduce the possibility of abuse, these bonus points may not, for example, total more than 50% of total points for that individual.

To promote the site's advertising services, a “Your Ad Here” or a “Sell This Ad Space” with a green “20 Points” tag can be placed beneath the Google-served ad block on every page in the site. These two messages can rotate. CPs can quickly learn to look for the green point tags on the site, and their eyes can naturally be drawn to these promotions.

Once the user base of the site builds, direct email can be used to communicate with the community of registered users and CPs. These email messages can be made available on an opt-in basis, but the Company can offer a 50 point incentive to CPs who choose to opt-in and remain on the email list for the duration of Phase I.

The site may be created and/or maintained by a huge staff of unpaid, motivated individuals. When certain CPs reach a certain threshold because of their quality and prolific contributions, they can be approached by the Data Management team to perform specific tasks in exchange for additional points.

For example, if the staff determines that very few of the state parks on the site have accurate web site links, they may specifically ask these CPs to locate that data and update the site. These same, trusted CPs may also be asked to monitor and approve site updates in real time.

Alternatively, point bonuses can be offered to the entire CP community wherever major gaps are discovered. In this manner, the Editorial team can effect the creation of huge amounts of data, simply by tweaking the point menu and posting the appropriate announcement.

In some embodiments, CPs may be rated on a scale of one to five stars. These ratings may be shown graphically next the CPs name. For example, the rights, obligations and restrictions of each star level are outlined below:
One Star—“New partner”

Postings are reviewed before going live.

May start posting immediately

Eligible for sales commissions for own ads
Two Stars—“Apprentice partner”

Promoted at 100 points

Postings are still reviewed before going live

Eligible for sales commissions for own and others' ads
Three Stars—“Active Partner”

Promoted at 1000 points.

Only spot reviews of postings
Four Stars—“Silver Partner”

Promoted at 10,000 points.

Only reviewed when complaints received

May serve as editor

Can have access to special projects which may be completed in exchange for points.

Can “man” the real-time console in exchange for points.
Five Stars—“Gold Partner”

Promoted at 100,000 points

May serve as dispute mediator

Points may be earned by uploading images and information to the site and/or for making quality edits to the existing site data. A menu of point awards can be displayed on the CP site, and individual point values can be shown in green next to “upload” and “edit” links.

The Editor-in-Chief can be responsible for managing the appropriate award levels to ensure the site is populated with the most useful information and pictures. From time to time, certain promotions can be offered to jump-start certain stagnant areas of the site. These promotions can be offered judiciously, however, to discourage individuals from “sand bagging” their submissions.

CPs may not receive all advertised points for a particular submission. If it is determined that an image is of poor quality, text is inconsistent with site standards, or edits are trivial or harmful, the Editor on call may decide to reduce the point award for that submission. If a pattern of poor submissions emerges, even after being notified of the concerns, that CP account can be turned off. He can, of course, get to keep all points accrued to date and participate, pro-rata, in the compensation awards.

CPs may also receive points in the form of a commission for local ad sales. When an advertiser uses the online form for setting up a local ad campaign, there can be a spot for optionally entering the user ID of the CP who “sold” the advertiser. This can encourage CPs to reach out into their local community to recruit local advertisers.

Individuals who wish to provide site content who are not qualified to be CPs or are not willing to provide the information necessary to sign up, may still participate as Non-Partner Contributors, with their contributions closely monitored by higher-ranked CPs. These individuals may choose to have the points they generate donated to an approved charity or exchange them for valuable coupons. These coupons could be sponsored by a vendor, who also would promote products on the CP section of the site.

Individual users who do not wish to sign-up for the charity program, may still participate in the forums and bulletin boards. They may also provide data and photographs about their home address only.

In some embodiments, to avoid the mess of keeping track of fractional points for trivial edits, the Company can offer a “Brownie Points” program. One Brownie Point can be awarded for each minor edit and each posting on a bulletin board or forum. These Brownie Points may be convertible to real points at the end of each Phase, with a conversion formula announced by management. No CP can be allowed to receive more than 5% of their total points from Brownie Points. This effectively eliminates the potential point abuse by an unscrupulous CP who repeatedly re-edits the same fields over and over again.

The site can be developed and deployed on state-of-the-art, Intel-based Linux servers. The servers can be loaded with the latest releases of Apache Web Server and the MySQL database management software. Language support can include PHP, Perl, and server-side Java.

Load testing can be performed upon application completion to determine the appropriate number of servers necessary. In addition to the server(s), a separate firewall and RAID disk array can be utilized. The size of the disk array can be determined, but can be a minimum of 4 Terabytes to support the voluminous satellite data (2 TB), street mapping data, and residential and business data.

Deep, hierarchical web sites can be designed in multiple ways, with pages fully hard-coded or completely generated on-demand via CGI scripts or other dynamic mechanisms.

A hard-wired, or static, HTML hierarchy is when each page is generated during a batch process, long before a user requests it. The advantage of this approach is the lower server load in that the web page is handed to the user on request, and no database or processing is required. The disadvantage is that many pages which are never visited are generated anyway. Another disadvantage is the amount of extra disk space necessary to store these completed pages, which contain duplicates of the same data in the database.

A dynamic hierarchy hides each page behind a script. No disk space is used to hold the pages since, in fact, no pages really exist. Everything is generated when the user request comes in. This is often the easiest way to implement a site with a tremendous amount of content. Search engines may not spider such hierarchies if the page calls are parameterized, and these pages won't appear in search engine indexes.

A hybrid approach consists of hard-coded HTML frames. These frames are trivially small on disk, containing just the page header and title information. Through a PHP call, the majority of the content of each page is generated on a just-in-time basis when the user requests it. This can be slower for the user, especially if a large amount of database access and calculations are necessary to generate the page.

For dynamic and hybrid approaches, the database is accessed for each page generation, causing significant database “thrashing” during periods of spidering and heavy user traffic. By contrast, in a static structure, the batch generation process typically reads large blocks of the database into memory, and generates multiple pages without additional database accesses.

During development, specific programs can be built which are capable of generating each page in the site. After benchmark tests are performed, a final determination can be made regarding static vs. dynamic vs. hybrid. The absolute requirement is that the spiders have the ability to index the entire site, with secondary consideration for disk usage and user response times.

The HTML hierarchy can mimic the link path hierarchy. The directory structure is as follows:

Country (/usa)
State (/usa/fl)
County (/usa/fl/Palm_Beach)
Zip Code (/usa/fl/Palm_Beach/33480)
Street (/usa/fl/Palm_Beach/33480/North_County_Road)
Address (/usa/fl/Palm_Beach/33480/North_County_Road/340)

Pages that traverse multiple directories may be located in the appropriate higher-level directory. For example, the page for the Northeast Region is in /usa and the page for the Everglades National Park which spans multiple counties is in /usa/fl. Cities and towns may be located in the appropriate county directory regardless of whether the town spans multiple zip codes or share a single Zip code with multiple towns.

All names may be encoded with the underscore character replacing any spaces, and special characters represented by a ‘%’ sign followed by the 2-digit hexadecimal code for the special character. State names may not encoded in the hierarchy, but may be stored in an appropriate table in the database.

All user-uploaded images can be stored directly in the Linux file system. Images exceeding a predetermined size can be auto-downscaled and both versions of the file can be stored.

The images can be stored in an identical but parallel hierarchy to the HTML hierarchy. For example, photographs about a specific address in Palm Beach County might be stored in /images/usa/fl/Palm_Beach/33480/North_County_Road/340. To make relative addressing of images less-verbose, a link from each terminal directory can be made to the corresponding images directory. In this manner, references to images can be accomplished with the “./images/<filename>.jpg” tag, rather than the full exhaustive pathname.

Text files can also have their own hierarchy with the appropriate prefix. For example, the directory /text/usa/fl/Palm_Beach/33480/North_County_Road/340 can hold all .txt files describing the specific property. These files can actually include a limited number of HTML tags to support bold and italic text, line breaks, and links.

The MySQL database can hold the following information: Mapping Data; Political Boundaries (States, Counties, Cities); Zip Codes; Roads; Waterways and Coastlines; Addresses (points and polygons); Residential Data; Names; Phone Numbers; Addresses (Normalized to mapping data); Tax Lot Data; Prior Sales; Lot and House Square Footage; Room Counts: BR, Ba, Lay; Tax Assessment and Tax Bill; Addresses (Normalized to mapping data); Commercial/Business Data; Name; Yellow Page Categories; Web Site Link; Addresses (Normalized to mapping data); Value Added Data; Mapping Polygons; Links to images and descriptive text; Edits, additions, and deletions to category 1-4 data above; Revision history; and other types of data.

Separate databases can be maintained to manage the following: CP point system; People database; and/or Ad server.

Data Reconciliation—The data can be purchased from several different sources, each of which have different formats for representing items like street names, house and apartment numbers, city and town names, and map coordinates.

Image Uploader—This tool can have a Java-based client and a separate server application. An HTML form based front-end may be utilized in the initial release.

Map Generator—The map data vendor can provide raw files which describe the location and shape of the various map elements. A server-side program generates map segments which represent a rectangular area at a specific zoom factor. This program extracts all objects from the map database which fall within the targeted rectangle, and render these objects at the correct scale. Value-added meta data like icons and photo thumbnails are appropriately placed on the constructed image. This tool builds click-maps to identify the “hot” areas on a map or satellite image.

Polygon Editing Tool—A client-side Java Applet can allow users to define regions by either selecting a set of smaller regions or drawing a polygon inside of a larger region. This Applet can communicate directly to a corresponding server-side application which stores this new polygon in the database.

Zoom and Pan Tool—This client-side Java Applet can allow users to zoom in and out and pan through any satellite image or map.

Real Time Administrator Console—A Perl program can serve HTML pages to the on-call Administrator. These pages can contain a concise view of edits and updates from three-star and lower CPs. They also can contain thumbnail-sized images being uploaded. The served pages can have boxes that the Administrator can check if the content is abusive, objectionable, or sub-standard.

Point Program Administration—A series of Perl programs and scripts can be developed to automatically keep track of CP points in the database.

Ad Server—A Perl script, initiated by a PHP call, can be responsible for checking whether a Company-served ad should be placed on a particular page. If not, the appropriately tagged Google AdWords call can be inserted.

Ad Campaign Setup Tool—A Perl script can handle this HTML-form which allows advertisers to specify the parameters of an ad campaign. After the information is entered, the client can be redirected to a third party credit card processing partner to collect the payment.

The illustrative embodiment of the site can include presenting data for all locations in the United States. The purchased data can include, but is not limited to, the following: Map Data; Yellow Page Data; Telephone Directory (White Page) Data; Satellite Imagery; Tax Records; US Census Data; and/or US Geological Survey Data

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The client device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art can realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for compensating a contribution, comprising:
receiving, via a communication module, a content contribution request from a client device;
determining, by a user compensation module, a compensation amount based on the content contribution request; and
modifying, by the user compensation module, a contributor account based on the compensation amount.

2. The method of claim 1, wherein the communication module and the user compensation module are implemented in a machine that comprises instructions stored in a machine-readable medium and a processor that executes the instructions.

3. The method of claim 1, further comprising storing the modified contributor account on a storage device.

4. The method of claim 1, further comprising the determining the compensation amount based on the content contribution request and a request category.

5. The method of claim 1, further comprising:
identifying, by the user collaboration module, a content data in the content contribution request; and
storing the content data in a storage device.

6. The method of claim 5, further comprising posting the stored content data on a wild, the wild is a geographically organized wild.

7. The method of claim 5, further comprising:
reviewing the stored content data via a user interface; and
posting, via the communication module, the stored content data on a wiki.

8. The method of claim 7, further comprising compensating, by the user compensation module, a reviewer for the reviewing the stored content data.

9. The method of claim 1, wherein the compensation amount includes a plurality of points.

10. The method of claim 9, further comprising providing cash to a contributor associated with the contributor account in exchange for the plurality of points.

11. The method of claim 1, wherein the content contribution request is geographic-location specific.

12. The method of claim 8, further comprising triggering the compensation amount for the content contribution request based on a location of the client device.

13. The method of claim 12, wherein, in the act of triggering, the location of the client device is a retailer and the content contribution request is a price of a product at the retailer.

14. A method for gathering data, comprising:
triggering, via a user collaboration module, a contributor for content contribution to a wiki based on a location of the content contributor.

15. The method of claim 14, further comprising compensating, via a user compensation module, the contributor for the content contribution.

16. The method of claim 15, wherein, in the act of triggering, the content contribution is a fuel price.

17. The method of claim 14, wherein in the act of triggering, providing a plurality of nearby locations to enable the contributor to specify the location of the content contributor.

18. The method of claim 14, wherein the user collaboration module is implemented in a machine that comprises instructions stored in a machine-readable medium and a processor that executes the instructions.

19. A system for compensating a contribution, comprising:
a communication module to receive a content contribution request from a client device; and
a first compensation module to determine a compensation amount based on the content contribution request and modify a contributor account based on the compensation amount.

20. The system of claim 19, further comprising a storage device to store the modified contributor account.

21. The system of claim 19, further comprising a user collaboration module to post a content data to a wild.

22. The system of claim 21, wherein the wild is a geographically organized wild.

23. The system of claim 19, further comprising a user collaboration module to review the content contribution request.

24. The system of claim 23, further comprising a second compensating module to compensate a reviewer for the act of reviewing.

25. The system of claim 19, wherein the first compensating module provides the compensation in the form of a plurality of points.

26. The system of claim 19, wherein the first compensating module provides the compensation in the form of cash to the contributor.

27. The system of claim 19, wherein the content contribution request received by the communication module is geographic-location specific.

28. The system of claim 19, further comprising, a user collaboration module to trigger the contributor for the content contribution request based on a location of the user device.

29. The system of claim 28, wherein the user device is a GPS-enabled phone.

30. The system of claim 28, wherein the user collaboration module is configured to identify the location of the content contributor as a retailer and request the content contribution of a price of a product at the retailer.

31. A system for gathering data, comprising:
a user collaboration module to trigger a contributor for content contribution to a wild based on a location of the content contributor; and
a communication module for receiving the content contribution request from the contributor.

32. The system of claim 31, further comprising a user compensation module to compensate the contributor for the content contribution.

33. The system of claim 31, wherein, the user collaboration module is configured to request the content contribution of a fuel price.

34. The system of claim 31, wherein, the user collaboration module is configured to provide a plurality of nearby locations and the communication module is configured to receive a choice from the plurality of nearby locations, thereby specifying the location of the content contributor.

35. The system of claim 31, wherein the user collaboration module provides the plurality of nearby locations in the form of retailer names.

36. A method for gathering data, comprising:
receiving, via a communication module, information regarding at least location information of a user;
determining, by a user collaboration module, traffic condition information proximate to the user by determining a speed of the user from the location information; and
compensating, by a user compensation module, the user for providing the location information.

37. The method of claim 36, wherein the act of receiving involves receiving the location information from a GPS-enabled device associated with the user.

38. The method of claim 36, further comprising posting the traffic information to a geographically organized wild, the user being associated with the wild.

39. A method for operating a wiki, comprising:
receiving, via a communication module, a request for a location-specific data capture;
requesting, via a database interface module, the location-specific data from a content provider of the wild;
receiving, via the communication module, the location-specific data from the content provider; and
compensating, by a user compensation module, the content provider for the location-specific data.

40. The method of claim 39, further comprising:
in the act of compensating, providing a greater compensation value depending on a type of request.

41. The method of claim 39, further comprising:
in the act of compensating, providing a greater compensation value depending on a value associated with fulfilling the request.

42. The method of claim 39, after the act of requesting and before the step of receiving a request, further comprising:
receiving an indication from the content provider that the content provider intends to provide the location-specific data;
reserving for a limited time, for the content provider, an opportunity to respond to the act of soliciting.

43. The method of claim 39, in the act of requesting, requesting only content providers proximate to the location:

44. The method of claim 39, in the act of receiving a request, collecting a credit card number to enable charging the credit card for the location-specific data.

45. The method of claim 39, further comprising providing the location-specific data to a source of the request.

46. The method of claim 45, further comprising billing the source of the request for the location-specific data.

47. The method of claim 39, wherein, in the act of receiving a request for a location-specific data capture, the location-specific data is at least one photograph of real property.

48. A method for generating a texture map overlay, comprising:
receiving, via a database interface module, a map indicative of a geographic location;
associating, by a texture layering render module, for at least one sub-region of the map, a texture indicative of the sub-region; and
generating, by the texture layering render module, a map overlay including a respective graphic image indicative of the associated texture.

49. The method of claim 48, wherein the texture is a photo-realistic image.

50. The method of claim 49, wherein the photo-realistic image is scalable.

51. The method of claim 48, wherein the texture is selected from a plurality of different textures able to render items found in a landscape.

52. The method of claim 48, further comprising varying opacity of the map overlay.

53. The method of any of the above claims are implemented in a machine that comprises instructions stored in a machine-readable medium and a processor that executes the instructions.
